(19) United States
(12) Patent Application Publication
(10) Pub. No.: US 2017/0154527 A1
(43) Pub. Date: Jun. 1, 2017

(54) APPARATUS AND METHOD FOR DRIVING ASSISTANCE

(71) Applicant: DENSO CORPORATION, Kariya-city (JP)

(72) Inventor: Naoto Yoshitomi, Kariya-city (JP)

(21) Appl. No.: 15/365,124

(22) Filed: Nov. 30, 2016

(30) Foreign Application Priority Data
Nov. 30, 2015 (JP) 2015-233986

(51) Int. Cl. G08G 1/0962; G08G 1/052; G08G 1/01

(52) U.S. Cl. CPC G08G 1/09623; G08G 1/01; G08G 1/052; B60Q 5/00

(57) ABSTRACT

A traffic signal recognition unit recognizes a state of traffic light in a travelling direction of a host vehicle. A position recognition unit recognizes a position of the vehicle. When a red light notification unit recognizes a state of a traffic light as being a red light at the traffic signal recognition unit and if the position recognized by the position recognition unit is a designated region permitting a left or right turn at the red light, a red light notification is notified to a driver if the driver has no intention of making a left or right turn or the intention is unclear, and if a left or right turn prohibited at a red light sign exists. In non-designated regions, the red light is notified to the driver except when a driving lane is a left or right turn only lane, or a direction of a direction indicator is the same as a direction shown by an arrow signal.

### CROSS-REFERENCE TO RELATED APPLICATION

This application is based on and claims the benefit of the priority from the earlier Japanese Patent Application No. 2015-233986 filed on Nov. 30, 2015 the description of which is incorporated herein by reference.

### BACKGROUND OF THE INVENTION

Technical Field

The present invention relates to techniques for assisting a driver who is driving, and more specifically relates to an apparatus for alerting the driver of a red light in a travelling direction of a host vehicle.

Related Art

Driving assistance has been adapted to obtain information of a road status of position ahead of a vehicle and a current position of the vehicle to increase a driver's awareness, avoid collision and provide efficient navigation thereby improving a gasoline mileage of the vehicle.

Patent literature 1 discloses a driving assistance apparatus which recognizes a driving lane in which a host vehicle is travelling, acquires traffic signal data of a traffic light in a travelling direction of a host vehicle, and alerts the driver to a red light existing in a travelling direction thereof, for example.

### CITATION LIST

[Patent Literature 1] JP 2008-242986 A

### SUMMARY

In order to save fuel, particular regions around the world have implemented a road system which permits a left or right turn even at a red light. Driving assistance is considered to be equally critical in such designated regions, in addition to non-designated regions. The Japanese Patent Literature 1 does not however accommodate such driving assistance in the designated regions which may cause inconvenience to drivers.

In view of the circumstances described above, it is an object of the present disclosure to provide suitable and flexible driving assistance at a red light regardless of the region.

A driving assistance apparatus of the present disclosure is provided with a traffic signal recognition unit, a position recognition unit, a notification unit (190) and a prohibition unit (steps S110 to S140 and steps S160 to S180).

The traffic signal recognition unit recognizes a state of traffic light in a travelling direction of a host vehicle. The position recognition unit recognizes a position of the host vehicle. The notification unit (S190) issues a notification of a red light when a state of a traffic light is recognized as being a red light at the traffic signal recognition unit. The prohibition unit (S110-S140, S160-S180) prohibits a notification from being issued by the notification unit if a determination unit determines the position of a host vehicle is within the designated regions.

The configuration set forth provides a suitable and flexible driving assistance system to the driver which can be applied to both designated regions and other regions that are not designated.

It is noted that the symbols set forth in in the specifications and the claims are provided to explicitly describe a preferred embodiment and do not limit the technical scope of the invention.

### BRIEF DESCRIPTION OF THE DRAWINGS

The following detailed description of the illustrative embodiments can be understood when read in conjunction with the following drawings. In the accompanying drawings:

FIG. 1 is a block diagram showing a configuration of a driving assistance apparatus according to a preferred embodiment;

FIG. 2 is a functional block of a red light notification unit;

FIG. 3 is a flow chart of a process executed by a red light signal notification unit;

FIG. 4 is explanatory diagram showing a left or right turn permitted state even at the red light; and

FIG. 5 is an explanatory diagram exemplifying a prohibition sign for a left or right turn at a red light.

### DETAILED DESCRIPTION OF THE PREFERRED EMBODIMENT

With reference to the accompanying drawings, a preferred embodiment of the present invention will be described.

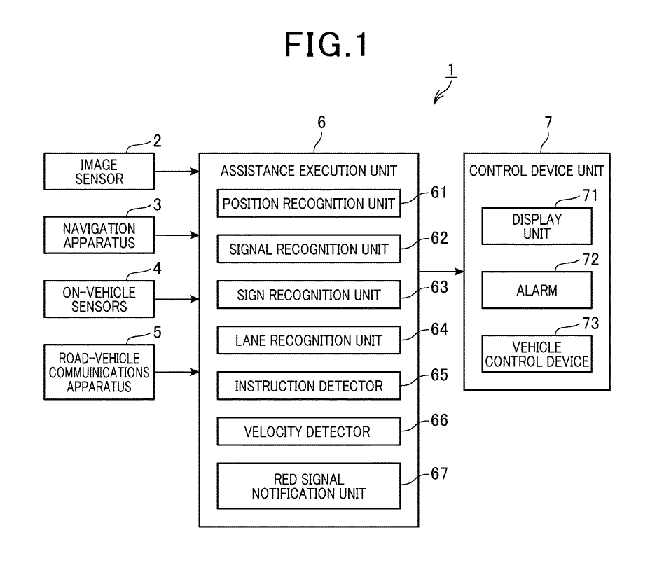

A driving assistance system 1 shown in FIG. 1 is a system mounted in a vehicle, is provided with an image sensor 2, a navigation apparatus 3, on-vehicle sensors 4, a road-vehicle communication device 5, an assistance execution unit 6, and a control device unit 7. The assistance execution unit 6 described here is equivalent to a driving assistance apparatus.

The image sensor 2 is provided with a CCD camera having a color indicator function, and is set to capture an image around a host vehicle, that is, at least in an area in front of the host vehicle.

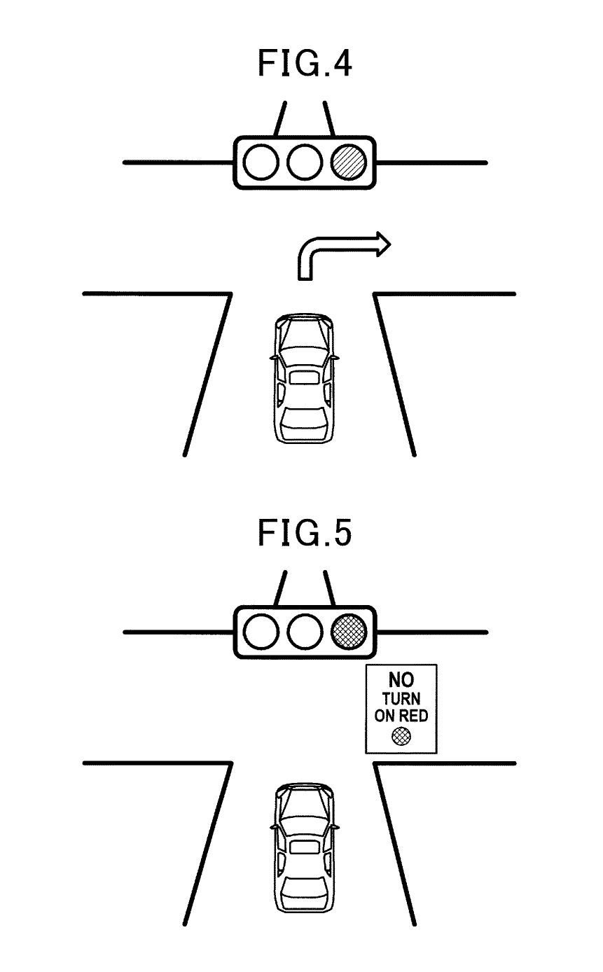

The navigation apparatus 3 is a known apparatus which acquires positional information from, for example, a GPS (Global Positioning System), displays a position of the host vehicle on a map of a surrounding area of the host vehicle, sets a route to a selected destination and provides route guidance to the destination. The navigation apparatus 3 maintains road regulation information, road sign information and lane information, for example. The road regulation information includes, for example, at least information on whether a region is a designated region as shown in FIG. 4, which is a region allowing a left or right turn at a red traffic light, for example, hereon, referred to as a “designated region” or whether it is not a “designated region” and therefore referred to as “non-designated region” hereon. The road sign information refers to information related to roads signs placed on a road side and signs on a road surface. Additionally, lane information is information related to a number of lanes and to left or right turn only lanes.

On-vehicle sensors 4 are made up of each type of sensors for detecting a driving operation and host vehicle behavior. In the example, at least a vehicle velocity sensor detecting a velocity of the host vehicle and a direction indicator sensor detecting an operational state of the direction indicator are included.

The road-vehicle communications device 5 acquires each item of information by communicating with a road side apparatus set in a vicinity of a road. The acquired information may include, for example, information showing an operational state of the infrastructure of a traffic light, in addition to same road regulation information that is maintained in the navigation apparatus 3 described above, sign information and lane information.

As is shown in FIG. 1, the control device unit 7 is provided with a display unit 71, an alarm 72 and a vehicle control device 73. The display unit 71 is a monitor displaying each type of image. The alarm 72 is provided with, for example, a speaker outputting an alarm sound and a voice message. The vehicle control device 73 is provided with each type of device for controlling an engine, a brake, and steering wheel, for example. The devices mentioned above are known devices therefore a detailed description is omitted here.

The assistance execution unit 6 is configured mainly of a known microcomputer having a CPU (central processing unit), a RAM (random-access memory), a ROM (read-only memory) and a semi-conductor, for example, a flash memory (hereon referred to as memory). Each function of the assistance execution unit 6 is enabled by the CPU executing a program stored in a non-transitory recording media. By executing the program a corresponding method is thus executed. The assistance execution unit 6 may be formed from one or more than one microcomputers. In the example, the memory refers to a program stored in the non-transitory recording media which refers to any media that stores data and information.

The assistance execution unit 6 is provided with at least a position recognition unit 61, a traffic signal recognition unit 62, a sign recognition unit 63, a lane recognition unit 64, an instruction detector 65, a velocity detector 66 and a red-light notification unit 67, as a functional system implemented by the execution of a program which is executed by the CPU. The method to actualize the components forming the assistance execution unit 6 is not limited to software, that is, either a part or all of the members described above may be actualized by, a logic circuit and an analog circuit-combined hardware, for example. The red light notification unit 67 is further provided with a notification unit 67A, a determination unit 67B, a prohibition unit 67C, a prohibition invalidation unit 67D, an intention determination unit 67E and a non-designated region prohibition unit 67F.

The position recognition unit 61, acquires a current position of the host vehicle via the navigation apparatus 3. The current position of the host vehicle may however be acquired directly from the GPS receiver, without going through the navigation apparatus 3. The traffic signal recognition unit 62 processes the image data acquired at the image sensor 2 and in doing so extracts a traffic light information in a travelling direction of the host vehicle and recognizes a state of the traffic light. The state of a traffic light is an operational state thereof. That is, the signal recognition system 62 recognizes at least whether or not the traffic light is on red. The information related to the state of the traffic light may be information acquired from infrastructure via the road-vehicle communication device 5.

The sign recognition unit 63 recognizes traffic signs included in the image, by processing the image acquired at the image sensor 2. The traffic signs include road signs shown on a road surface, in addition to road signs shown at a road side. As shown in FIG. 5, traffic signals subjected to recognition are road signs used in the designated regions, which include at least, a sign prohibiting a right turn at a red light or a sign prohibiting a left turn at a red light (hereon referred to as “a prohibition sign for a left or right turn at a red light”), and a road sign or road surface sign showing the host vehicle lane is a turn left or right only lane. The information used may be information acquired from the navigation apparatus 3 and information acquired via the road-vehicle communication device 5 for example.

The lane recognition unit 64 recognizes a driving lane which is a lane in which the host vehicle is currently driving (traveling on), by processing the image acquired at the image sensor 2. Incidentally, recognition of the driving lane, is however not limited to processing the acquired image, and may be recognized by a combination of road information acquired from the navigation apparatus 3 and the position of the host vehicle recognized at the position recognition unit 61.

The instruction detector 65 detects the operational state of the direction indicator, based on a turn signal which is output from the direction indicator sensor included in the on-vehicle sensors 4. The velocity detector 66 detects vehicle speed which is a velocity of the host vehicle based on an output of the velocity sensor included in the on-vehicle sensors 4.

The red light notification unit 67 issues a notification about a red light based on recognition results of the position recognition unit 61, the traffic signal recognition unit 62, the sign recognition unit 63, and the lane recognition unit 64, and detection results of the instruction detector 65, and the velocity detector 66.

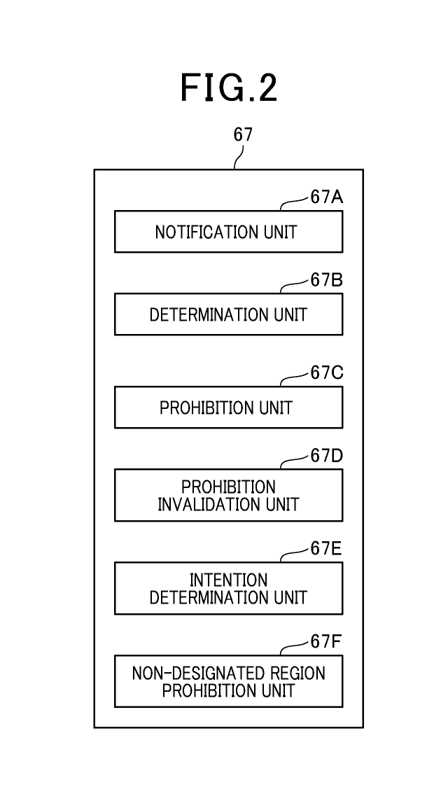

Components configuring the red light notification unit 67 will now be described with reference to the functional block diagram shown in FIG. 2. The notification unit 67A issues a notification of a red light signal when the state of a traffic light is on red (67:S190). The determination unit 67B determines whether the position of the host vehicle is in a designated region. The prohibition unit 67C prohibits the notification from being issued by the notification unit 67A when a positional condition is satisfied (67:S110-S140, S160-S180). More specifically, if the positional condition of the host vehicle is determined to be within the designated regions where a left or right turn is permitted at a red light, the notification is not issued.

The prohibition invalidation unit 67D invalidates the prohibition of issuing the notification of a red light issued by the prohibition unit 67C when a traffic sign recognized by the sign recognition unit 63 shows that a left or right turn is prohibited if a traffic light is on red (67:150).

The intention determination unit 67E determines that a driver of the host vehicle has an intention to turn left or right as an intention condition (67:S120-S140, S160-S180). The non-designated region prohibition unit 67F prohibits the issue of the notification of a red light to the driver in non-designated regions, when the prohibition unit 67C recognizes the position as being in a non-designated region and an arrow signal is recognized at the signal recognition unit 63 (67:S110, S160-S180). This applies if the intention of the driver determined at the intention determination unit 67E and an arrow signal are the same. The arrow signal mentioned here permits a left or a right turn at a red light. The process of a red light notification will be further described in the next unit.

Process

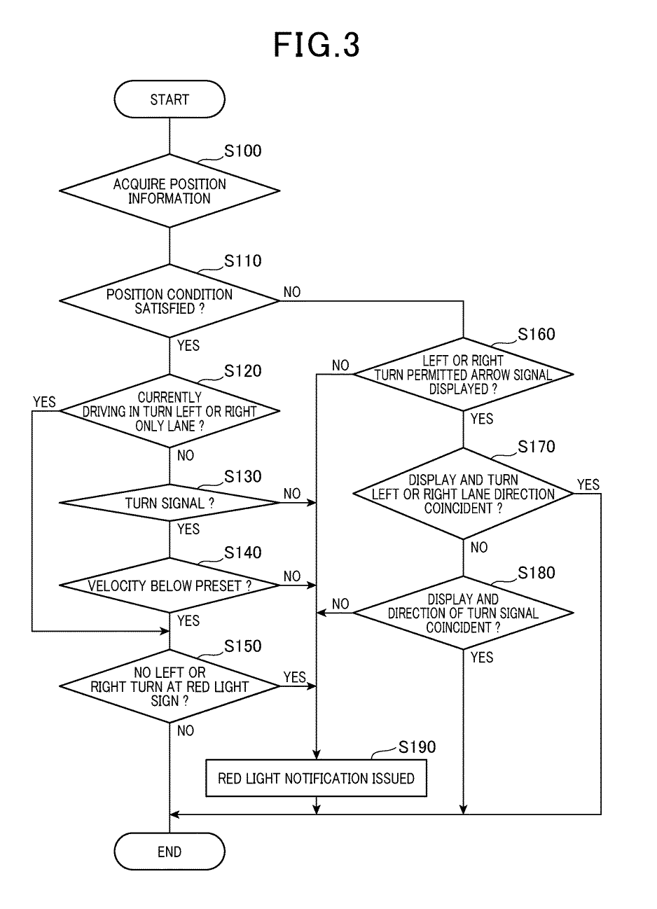

Now referring to the flow chart in FIG. 3, a red light notification process executed by the red light notification unit 67 will be described. The process is initiated when a red light is recognized at the traffic signal recognition unit 62.

Once the process is initiated, at step S100 the position of the host vehicle is acquired. At step S110, the CPU functioning as the traffic signal recognition unit 62 determines whether a current position of the host vehicle is within the designated regions as a positional condition based on the current position recognized at the position recognition unit 61 and pre-specified information of designated regions, acquired via the navigation apparatus 3 or via the road-vehicle communication device 5. Specifically, the CPU determines whether the positional condition is satisfied, in other words, if the current position of the host vehicle is within a designated region permitting a left or right turn at a red light. When the positional conditions are satisfied the process can proceed to step S120, when the positional condition are not satisfied the process proceeds to step S160.

At step S120, the CPU determines if the driving lane of the host vehicle is a turn left or right only lane, based on the recognition results at the indication recognition unit 63 and the lane recognition unit 64. When the driving lane of the host vehicle is a turn left or right only lane, it is judged accordingly that the driver intends to make a left or right turn and the process can proceed to step S150. When the lane is not a left or right turn only lane, the process proceeds to step S130. The S120 is equivalent to the intention determination unit 67E.

At step S130, the CPU determines if there is a turn signal, more specifically, determining whether the driver instructs a right turn or a left turn based on detection results of the instruction detector 65. When the turn signal is activated the process can proceed to step S140 and when the turn signal is not activated, it is assumed that the driver has an intention to go straight and the process proceeds to step S190.

At step S140 the CPU determines if the vehicle speed is lower than a pre-set threshold velocity, based on detection results of the velocity detector 66. When the vehicle velocity is lower than the threshold velocity, it is judged that the driver intends to make a left or right turn and the process can proceed to step S150. When the vehicle velocity is determined as being higher than the threshold velocity, the driver's intention is determined as being unclear and the process proceeds to step S190.

At step S150 the CPU determines whether the prohibition sign for a left or right turn at a red light is recognized, based on recognition results of the recognition determination unit 63. When the prohibition sign for a left or right turn is recognized, the process can proceed to step S190, on the other hand, when the prohibition sign is not recognized it is determined that a left or right turn can be made even at a red light, and the process is completed without the notification of a red light.

At step S160, the CPU determines whether an arrow signal permitting left or right turn is shown based on recognition results of the traffic signal recognition unit 62. If the arrow signal is shown the process can proceed to step S170, if however it is not shown the process proceeds to step S190.

At step S170, the CPU determines whether the driving lane of the host vehicle is a left or right turn only lane, and also whether a direction of the left or right turn is the same as a direction of an arrow sign, based on recognition results of the sign recognition unit 63 and on the lane recognition unit 64. At this point, if affirmative judgment is made, more specifically, if determined that a left or right turn can be made even at a red light, notification of the red light is thus omitted, and the process is completed. When the left or right turn is not the same as the direction shown on an arrow, the process proceeds to step S180.

At step S180, the CPU determines whether the direction of the detected turn signal is the same as the direction of the arrow sign based on detection results of the instruction detector 65. When the direction of the turn signal is the same as the direction of the arrow sign, it is determined that a left or right turn is permitted even at a red light, thus, notification of a red light is omitted and the process is completed. When the direction is determined to be not the same as the arrow sign, the process proceeds to step S190.

At step S190, optical or audible notification enables the driver to recognize that a light is on red, using at least one of a display unit 71 and an alarm 72, and the process is completed.

It is noted that, step S190 is the notification unit 67A, steps S110 to S140 and steps S160 to S180 are the prohibition unit 67C, step 150 is the prohibition invalidation unit 67D, steps S120 to S140 and steps S160 to S180 are the intention determination unit 67E, step S110 and steps S160 to S180 are the non-designated region prohibition unit 67F. The intention conditions are affirmative at step S120, affirmative at both steps S130 and S140, and affirmative at either step S170 or step S180.

### Effects of the Disclosure

As described above, according to the preferred embodiment, in designated regions which permit a left or right turn at a red light, a red light signal is still notified if the driver's intention to make a left or right turn is unclear, and if there is the prohibition sign for a left or right turn at a red light. In the non-designated regions, the red light is notified to the driver, unless the left or right turn only driving lane or the direction shown by the direction indicator and the direction shown by the arrow sign are the same. Additionally, in the preferred embodiment, when the red light is recognized, unnecessary notifications are decreased resulting in suitable and flexible driving assistance that accommodates assistance in both pre-specified and non-designated regions.

### Other Embodiments

A mode to carry out the invention has been illustrated and described herein, but it should be understood that various changes and modifications may be made without departing from the spirit and the scope of the invention.

For example, in the embodiment notification of a red light signal is adopted, however, other means of notification may be employed to notify to the driver that a left or right turn is permitted even at a red light in the relevant areas when necessary.

In a further example, an element in the embodiment having a function may be divided into a plurality of elements, on the other hand, a plurality if elements having one function may be combined into one element. A part of the elements in the preferred embodiments may also be omitted, and at least a part of the elements in the present configuration set forth may be incorporated (added or substituted) into another embodiment.

In addition to the driving assistance apparatus actualized as the assistance execution unit described above, a program for functioning a computer, a non-transitory recording media of the program recorded in, for example a semiconductor memory, a driving assistance method and the like, that is, various aspects of the claimed subject matter can be used to actualize the driving assistance apparatus.

### REFERENCE SIGN LIST

1 driving assistance system, 2 image sensor, 3 navigation apparatus, 4 on-vehicle sensors, 5 road-vehicle communication device, 6 assistance execution unit, 7 control device unit, 61 position recognition unit, 62 traffic signal recognition unit, 63 sign recognition unit, 64 lane recognition unit, 65 instruction detector, 66 velocity detector, 67 red light notification unit, 71 display unit, 72 alarm, 73 vehicle control device.

What is claimed is:

1. A driving assistance apparatus, comprising:
a traffic signal recognition unit which recognizes a state of a traffic light in a travelling direction of a host vehicle;
a position recognition unit which recognizes a position of the host vehicle;
a notification unit (S190);
a determination unit (S100); and
a prohibition unit (S110-S140, S160-S180),
wherein the notification unit issues a notification of a red light when the state of the traffic light is recognized as being a red light by the traffic signal recognition unit,
the determination unit determines whether the position of the host vehicle is in a designated region which allows turning of at least one of a left or right turn, and
the prohibition unit performs a prohibition operation prohibiting an issue of the notification from the notification unit if the position of the host vehicle is determined to be within the designated region, determined by the determination unit.

2. The driving assistance apparatus according to claim 1, comprising;
a sign recognition unit which recognizes a traffic sign existing in a vicinity of the host vehicle; and
a prohibition invalidation unit (YES at S150) invalidating the prohibition operation of the prohibition unit, when the sign recognition unit recognizes a traffic sign that shows turning of at least one of a left or right turn is prohibited if a traffic light is on red.

3. The driving assistance apparatus according to claims 1, wherein the prohibition unit comprises;
an intention determination unit (S120-S140, S160-S180) which determines whether the driver of the host vehicle has an intention of turning of at least one of a left or right turn,
wherein if the intention determination unit determines that the driver of the host vehicle has the intention of turning of at least one of a left or right turn and the position of the host vehicle is recognized by the position recognition unit as being in the designated area, the issue of the notification, notifying the driver of a red light signal is prohibited from being issued by the notification unit.

4. The driving assistance apparatus according to claim 3,
wherein the prohibition unit further comprises;
a non-designated region prohibition unit (S110, S160-S180) prohibiting the issue of the notification in non-designated regions, issued from the notification unit; if the position of the host vehicle is recognized as being the non-designated region and an arrow signal which permits turning of at least one of a left or right turn is shown at the traffic signal recognition unit, when the intention of the driver determining turning at least one of left or right turn at the intention determination unit and the arrow signal display are the same.

5. The driving assistance apparatus according to claim 3, further comprising;
a lane recognition unit which recognizes a driving lane that is the driving lane of the host vehicle,
wherein the intention of turning of at least one of a left or right turn is determined when the lane recognition unit recognizes the driving lane as turn left or right only lane.

6. The driving assistance apparatus according to claim 3, further comprising;
an instruction detector detecting a state of a direction indicator,
wherein the intention determination unit determines the intention of turning of at least one of a left or right turn when the instruction detector detects the directional indicator as being in an operating state.

7. The driving assistance apparatus according to claim 6, further comprising;
a velocity detector detecting a velocity of the host vehicle,
wherein the intention determination unit determines the intention of turning of at least one of a left or right turn when the instruction detector detects the directional indicator being in the operating state and the velocity detector detects the velocity of the vehicle as being lower than a pre-set thresh hold.

8. A method of assisting a driver of a vehicle, comprising steps of:
detecting a position of a host vehicle;
determining whether the position of the host vehicle is detected in a designated region which allows turning of at least one of left or right at a red light;
issuing notification of a red light when the state of the traffic light is recognized as being a red light; and
prohibiting the notification of a red light if the position of the host vehicle is determined to be in a designated region.

9. The driving assistance apparatus according to claim 2,
wherein the prohibition unit comprises;
an intention determination unit (S120-S140, S160-S180) which determines whether the driver of the host vehicle has an intention of turning of at least one of a left or right turn,
wherein if the intention determination unit determines that the driver of the host vehicle has the intention of turning of at least one of a left or right turn and the position of the host vehicle is recognized by the position recognition unit as being in the designated area, the issue of the notification, notifying the driver of a red light signal is prohibited from being issued by the notification unit.

10. The driving assistance apparatus according to claim 4, further comprising;
a lane recognition unit which recognizes a driving lane that is the driving lane of the host vehicle, wherein the intention of turning of at least one of a left or right turn is determined when the lane recognition unit recognizes the driving lane as turn left or right only lane.

11. The driving assistance apparatus according to claim 4, further comprising;
an instruction detector detecting a state of a direction indicator,
wherein the intention determination unit determines the intention of turning of at least one of a left or right turn when the instruction detector detects the directional indicator as being in an operating state.

12. The driving assistance apparatus according to claim 5, further comprising;
an instruction detector detecting a state of a direction indicator,
wherein the intention determination unit determines the intention of turning of at least one of a left or right turn when the instruction detector detects the directional indicator as being in an operating state.
